(19) United States
(12) Patent Application Publication
(10) Pub. No.: US 2018/0139447 A1
(43) Pub. Date: May 17, 2018

(54) SYSTEMS AND METHODS FOR PERFORMING SELF-SIMILARITY UPSAMPLING

(71) Applicant: TMM, Inc., Wilmington, DE (US)

(72) Inventors: Da Qing ZHOU, Richmond (CA); Nicolas BERNIER, Vancouver (CA); David KERR, Vancouver (CA)

(21) Appl. No.: 15/574,242

(22) PCT Filed: May 11, 2016
(86) PCT No.: PCT/US2016/031877

§ 371 Date: Nov. 15, 2017

Related U.S. Application Data
(60) Provisional application No. 62/162,264, filed on May 15, 2015.

(51) Int. Cl. H04N 19/132; G06T 3/40

(52) U.S. Cl. CPC H04N 19/132; G06T 3/4053

(57) ABSTRACT

In one aspect, the invention relates to a method of performing upsampling, that includes the steps of: receiving an input image; generating an initial upsampled image using the input image; generating a low-passed image using the input image; and performing self-similarity upsampling using the upsampled image and the low-passed image.

### PRIORITY

This application is being filed on 11 May 2016, as a PCT International patent application, and claims priority to U.S. Provisional Patent Application No. 62,162,264, filed May 15, 2015, the disclosure of which is hereby incorporated by reference herein in its entirety.

### INTRODUCTION

With the proliferation of computing devices, content consumed by users is often consumed across different devices. However, in many instances, content is generated for a specific form factor. Content may be generated and/or formatted for a specific screen size or resolution. For example, content may be generated for SDTV, HDTV, and UHD resolution. When content is transferred between different devices, it may be necessary to reformat the content for display on the different device. With respect to visual content, such as images or videos, content generated for a lower resolution device (e.g., content for mobile devices, SDTV content, etc.) may have to be altered when displayed on a higher resolution device, such as a HD television or a UHD television. One way of converting visual content is by performing upsampling on the content. However, because upsampling is based upon interpolation, the upsampled representation may suffer from degraded image quality. For example, an upsampled image (or video frame) may have jagged or blurred edges, reduced quality, and loss of image truthfulness. The goal, therefore, in the context of video and image upsampling, is to produce a representation that maintains image quality, edge clarity, and image truthfulness. Furthermore, in the context of displaying video, it is desirable that the upsampling is performed in real-time.

### BRIEF DESCRIPTION OF THE DRAWINGS

The same number represents the same element or same type of element in all drawings.

FIG. 1 is an exemplary method for performing self-similarity upsampling.

FIG. 2 provides an example of a self-similar block.

FIG. 3 is an example of overlapping patch blocks.

FIG. 4 is an embodiment of a method for performing self-similarity on a video.

FIG. 5 illustrates one example of a suitable operating environment in which one or more of the present embodiments may be implemented.

FIG. 6 is an embodiment of an exemplary network in which the various systems and methods disclosed herein may operate.

### SUMMARY

In one aspect, the invention relates to a method of performing upsampling, that includes the steps of: receiving an input image; generating an initial upsampled image using the input image; generating a low-passed image using the input image; and performing self-similarity upsampling using the upsampled image and the low-passed image.

### DETAILED DESCRIPTION

The aspects disclosed herein relate to systems and methods for performing upsampling on digital content. In aspects, digital media may include, for example, images, audio content, and/or video content. Generally, upsampling is a form of digital signal processing. Upsampling may include the manipulation of an initial input to generate a modified or improved representation of the initial input. In examples, upsampling comprises performing interpolation on content to generate an approximate representation of the content (e.g., an image, audio content, video content, etc.) if the content was sampled at a higher rate or density. Put another way, upsampling is a process of estimating a high resolution representation of content based upon a course resolution copy of the content. For example, audio content initial sampled at 128 kbps can be upsampled to generate a representation of the content at 160 kbps. Video content recorded in standard definition may be upsampled to generate a high definition representation of the content. For ease of discussion, the present disclosure will describe the technology with respect to upsampling video content. However, one of skill in the art will appreciate that the aspects disclosed herein may be performed on any type of content without departing from the spirit of this disclosure.

Self-similarity may be employed to enhance the quality of an upsampled representation. In aspects, an upsampled representation may be an image, audio, or video. The term self-similarity comes from fractals which rely on local and non-local self-similarity of images. A fractal is a mathematical set that exhibits a repeating pattern that is displayed at different scale. If the repeating pattern is the same at every scale, the repeating pattern is a self-similar pattern. An object that is self-similar is an object in which the whole of the object has the same shape as one or more parts of the object. Aspects disclosed herein relate to a self-similarity upsampler that takes advantage of local and non-local self-similarity in an object, such as, for example, an image. The aspects disclosed herein may perform upsampling without the use of contracting functions.

For example, in one aspect a self-similarity upsampler may be used to enhance the high frequency band of an upsampled image. A Blackman filter may be used to generate an upsampled image. A Gaussian filter may be used to generate a low-passed image. Other filters may be used to generate the low-passed image. The self-similarity upsampler may search for matching blocks between upsampled image and the low-passed image. A high-passed imaged may be obtained by subtracting the low-passed image from the input image. And finally the matched high-passed blocks may be added to the upsampled image to generate a final upsampled image.

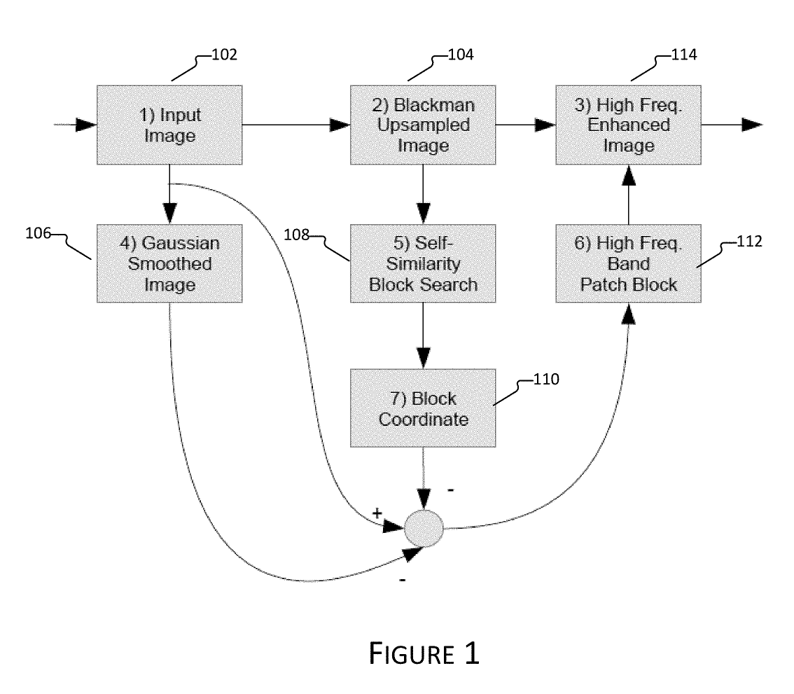

FIG. 1 is an exemplary method 100 for performing self-similarity upsampling. Flow begins at operation 102 where an input image is received. Flow continues to operation 104 where the original image is upsampled. In one aspect, a Blackman filter may be applied to the original image to produce an initial upsampled image. For example, the following standard Blackman filter may be applied to the original image to produce an upsampled image of any size:

Blackman_filter( )
{

sinc(t) x Blackman_window (t / 3.0)

}
where sinc(t) is defined to be sin(t)/t

While operation 104 is described as applying a Blackman filter, other types of filters or processes may be utilized at operation 104 to generate the initial upsampled image. In one example, weighting parameters may be determined at operation 104. One of skill in the art will understand that other types of filters can be employed with the aspects disclosed herein.

At operation 106, the input image may be smoothed using a Gaussian smoothing filter to generate a smoothed image or a low-passed image. In one example, the Gaussian filter may use a kernel size of 3×3. For example, the kernel values may be:

| | | | | | |
|---|---|---|---|---|---|
| 3.667042 | f | 19.149521 | f | 3.667042 | f |
| 19.149521 | f | 100.0 | f | 19.149521 | f |
| 3.667042 | f | 19.149521 | f | 3.667042 | f |

Other values may be used without departing from the scope of this disclosure. In aspects, the Gaussian filter is toned according to the single scaling step of √2. The smoothed image may then have a similar degree of blurring as the upsampled image. The self-similarity block search (described in more detail below) may produce optimal results when a similar degree of blurring between the smoothed and the upsampled images is used. In one example, operations 104 and 106 may be performed sequentially. In other examples, operations 104 and 106 may be performed in parallel.

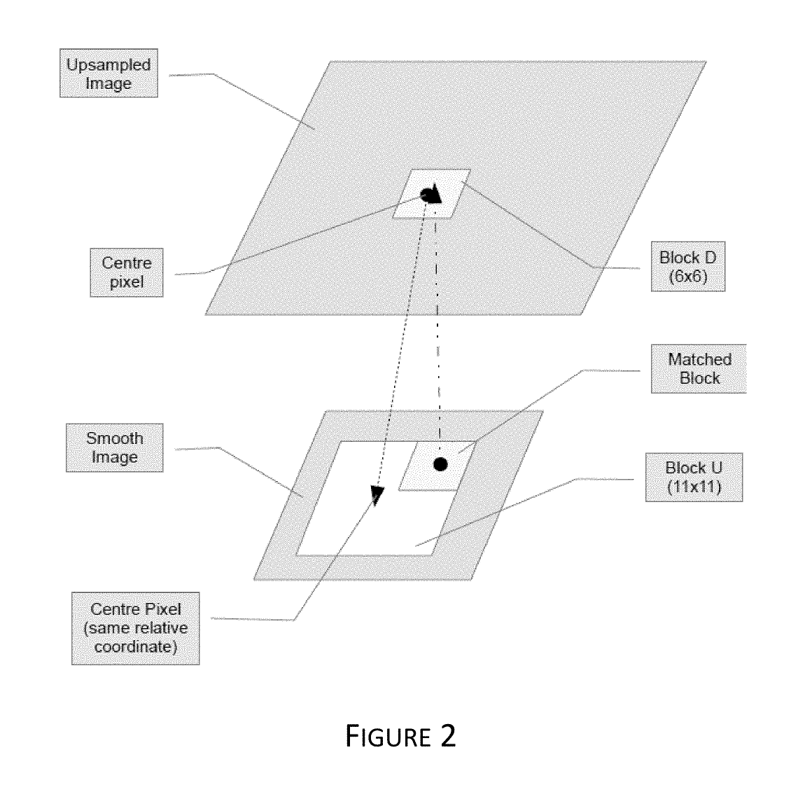

At operation 108, self-similarity blocks may be identified in the upsampled image generated at operation 104. In aspects, the initial upsampled image generated at operation 104 may exhibit similarity with the initial image received at operation 102. FIG. 2 provides an example of a self-similar block. An original image may be divided into subsections. For example, an upsampled image 202 may be divided into a 6×6 block, such as Block D of FIG. 2. The center of Block D (e.g., the center pixel) has a corresponding pixel at a within an input image. A block having the same size as Block D may be identified in an upsampled image, represented by Block U in FIG. 2. The center pixels of Block U and Block D have the same relative coordinates. Block U is blurred as compared to Block D.

A Gaussian smoothing filter may be applied to generate a low-passed image. In one example, the same degree of blurring may be applied both the smoothed image and the upsampled image. For example, a Gaussian filter may be Block U in the upsampled imaged may be examined to find a corresponding pixel in the smoothed image. The corresponding pixel may have the same relative coordinate as the center pixel of Block U. A corresponding block (e.g., a block having the same size as Block D) may be identified around the corresponding pixel in the smooth image. The determined corresponding block is therefore similar to Block U. The corresponding block may then be used to enhance the high frequency band of Block U.

Returning to operation 108 of FIG. 1, identification of one or more self-similar blocks in the upsampled image may be used to generate a in a set of block coordinates at operation 110. The upsampled image (2) (FIG. 1) is first partitioned into smaller blocks, e.g. 6×6 pixel blocks. These are referred to as patch blocks (block D in FIG. 2). Patch blocks may overlap. Using the center pixel of each patch block, locate the same relative coordinate in the smoothed image (4) (FIG. 1). This is Block U in FIG. 2. Block U is an 11×11 pixel block. Within block U, locate the best matching block to block D which is a 6×6 pixel block. A standard mean-square error (MSE) is used to measure the degree of matching. Obviously, the block with the least MSE is the best matching block.

The set of block coordinates may identify the one or more self-similar blocks determined at operation 108. Self-similarity block search may be an algorithm to locate information that can be used to augment the high frequency portion of the upsampled image.

The upsampled image generated at operation 104 may be partitioned into smaller blocks, e.g. 6×6 pixel blocks. These are referred to as patch blocks (Block D in FIG. 2). Patch blocks may overlap. The center pixel of each patch block may be used to locate the same relative coordinate in the smoothed image generated at operation 106. This is represented as Block U in FIG. 2. Block U may be an 11×11 pixel block. Within Block U, the best matching block to Block D may be identified. The best matching block may be a 6×6 pixel block. A standard mean-square error (MSE) may be used to measure the degree of matching. The block with the least MSE may be the best matching block. The best matching block may be referred to as final Block D′. The corresponding block may then be located from the original image. The block from the original image may be referred to as Block I. Blocks D′ and I have the following characteristics:
Block I has the same coordinate and size as block D′.
Block I-D′ is the high frequency band
Block I-D′ may be patch into the path block within the upsampled image.

At operation 112, a high frequency image may be generated by subtracting the low-passed image from the input image. At operation 112, self-similar blocks, identified by the coordinates generated at operation 110, of the high-passed image are added to the high-frequency image to generate the final high passed self-similarity enhanced image. At operation 114, a final high frequency enhanced image may be generated by adding the upsampled image generated at operation 104 with the high-passed self-similarity enhanced image generated at operation 112.

Further aspects of the present disclosure relate to determining weighting parameters. For example, Blackman weighted parameters may be determined. In one example, each row of the original input image may have N number of pixels and each row of the upsampled image may have M number of pixels, where N>N. The coordinate for each pixel in the row may then be identified as (0 . . . N−1) for the original input image. The coordinate for each pixel in the upsampled image can be determined using the following formula:

$$Coordinate = i \times \frac{N}{M} , where i has the range of ( 0 … M - 1 ) .$$

In examples, each pixel may systematically be used as a center pixel to find all integers within [center−3 . . . center+3] where the center may be determined by the equation above. With a filter, such as a Blackman filter, the integer coordinates may be applied to determine weighting parameters. Other filters may be used. This calculation may be repeated for each row and/or each column in the image. In examples, the weighting parameters may not change if the input and output frame sizes remain constant. Therefore, there may not be a need to perform this calculation for multiple frames in a video.

Additional aspects of the present disclosure relate to determining upsampling or scaling factors. In aspects, upsampling may result in higher quality when the upsampling factors or scales are small, preferably <1.5. An image may need to be upsampled in multiple steps to reach the desired target scale. In other words, the upsampling algorithm may be an iterative algorithm. For example, to reach a scale of 2×, an image should be upsampled firstly by a scale of <1.5 before upsampling with a scale factor of 2. The algorithm uses scale factors of multiples of \sqrt{2}. For example:
To obtain a 2× upsampling:
   upsampled by √2, then
   upsampled by 2.
To obtain a 4× upsampling:
   upsampled by √2,
   upsampled by 2,
   upsampled by 2×√2,
   upsampled by 4.

Additional aspects of the present disclosure relate to determining patch blocks. In examples, a patch block size may be 6×6 pixels. Other block sizes may be used without departing from the scope of this disclosure. In order to reduce noise, the patch blocks may overlap each other. Overlapping pixels may be characterized by having more than one patch block covering the same region. Average sums for the overlapping pixels may be calculated and added to the upsampled image. An average sum may be determined by summing the overlapping pixels in a patch block and dividing the sum by the number of overlapping pixels in the block. In embodiments, a patch block may be determined using the following formula:

Patch Block=Input Image Block−Smoothed Image Block

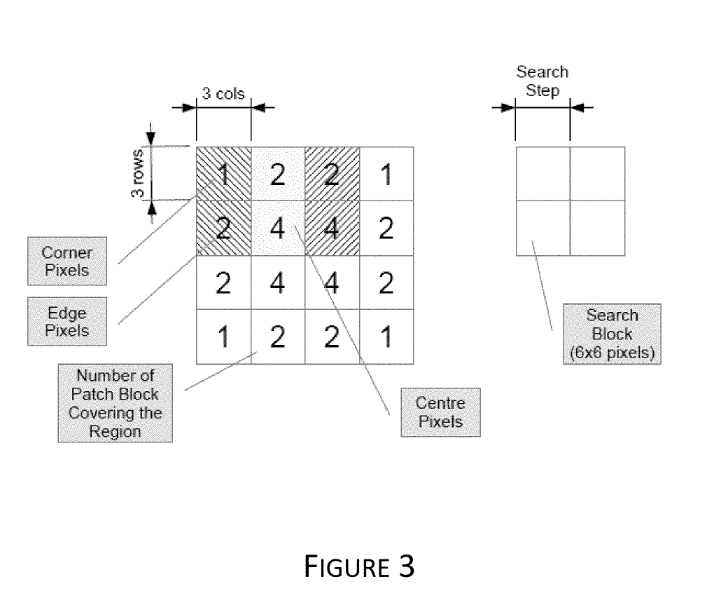

In examples, patch blocks may be determined starting from the top left corner of an image. The patch block may be iterated/moved by 3 columns for each pass in order to produce overlapping regions of 6×3 pixels. Iterating by 3 rows for each pass creates overlapping regions of 3×6 pixels, as illustrated in FIG. 3. In examples, the corner pixels may be covered by a single patch block, the edge pixels may be covered by 2 patch blocks, and the center pixels may be covered by 4 patch blocks.

Aspects of this disclosure may modify color planes. The YUV420 color space may be used when performing self-similarity upsampling. Since the Y-plane contains the bulk of the image, only the Y-plan may be fully upsampled. That is, only the Y-plan will undergo the aforementioned self-similarity algorithm. The U and the V planes are only used to augment the result and final colors. That is, the UV planes may be upsampled (without self-similarity) using an upsampling algorithm such as, but not limited to, the Blackman Algorithm. All three planes may be subjected to the \sqrt{2} upsampling constraint described above. In the YUV420 color space domain, the Y plane contains ½ of the image information and each of the UV planes contain ¼ of the image information. Y is the luminance and UV is the chrominance.

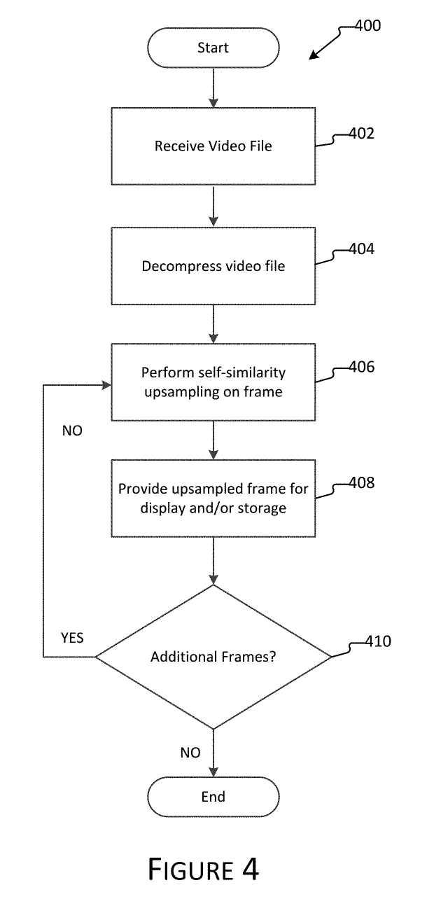

FIG. 4 is an embodiment of a method 400 for performing self-similarity upscaling on a video. In examples, method 400 may be executed on a device comprising at least one processor configured to store and execute operations, programs or instructions. However, method 400 is not limited to such examples. The method 400 may be implemented in hardware, software, or a combination of hardware and software. In other examples, method 400 may be performed by an application or service executing a location-based application or service. Flow begins at operation 402 where a video file is received. The received video file may be in any type of video file format. For example, the video file may be an H.264/MPEG-4 AVC file, a VP8 file, a WMV file, a MOV file, among other examples. Flow continues to operation 404 where the video file is decompressed. The decompression performed at operation 402 depends on the file format of the received video file. Flow continues to operation 406 where the self-similarity upsampling is performed on a frame of the video file. For example, the self-similarity upscaling method described with respect to FIG. 1 may be performed at operation 402. Upon completion of the upsampling, flow continues to operation 406 where the upsampled frame is provided for display or storage. For example, the upsampled video frame may be displayed on a screen at operation 406. Alternatively or additionally, the upsampled frame may be stored for later processing at operation 406. Flow continues to decision operation 410 where it is determined if additional video frames exist. If there are additional video frames to be processed, flow branches YES and returns to operation 406. If there are no additional frames, the upsampling of the video is complete, flow branches NO, and the method 400 terminates.

Having described various embodiments of systems and methods that may be employed to self-similarity upsampling, this disclosure will now describe an exemplary operating environment that may be used to perform the systems and methods disclosed herein. FIG. 3 illustrates one example of a suitable operating environment 300 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

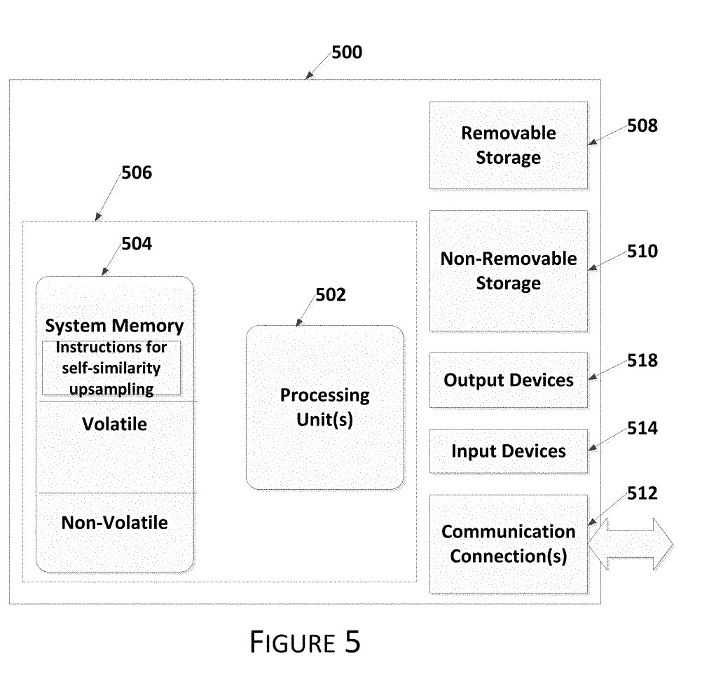

In its most basic configuration, operating environment 500 typically includes at least one processing unit 502 and memory 504. Depending on the exact configuration and type of computing device, memory 504 (storing, instructions to perform the self-similarity upsampling aspects disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as LAN, WAN, point to point, etc. In embodiments, the connections may be operable to facility point-to-point communications, connection-oriented communications, connectionless communications, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

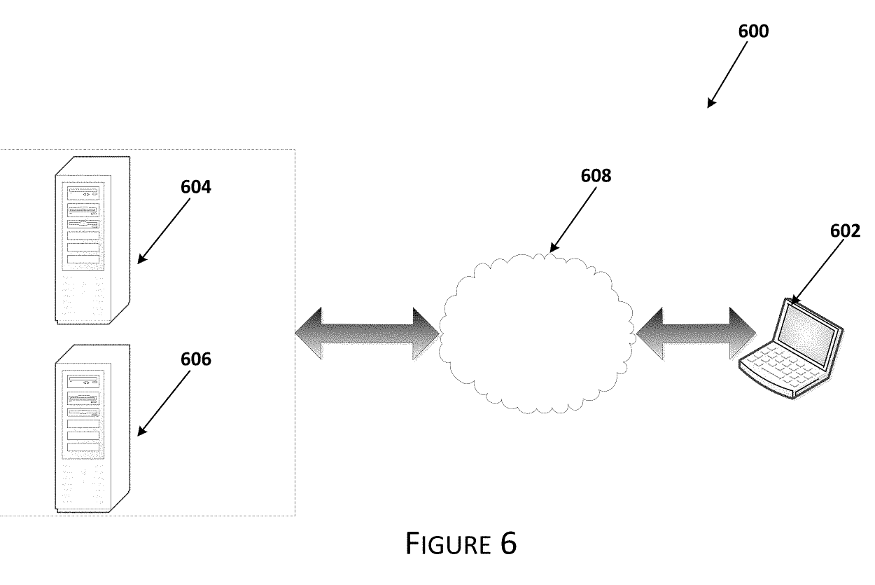

FIG. 6 is an embodiment of a system 600 in which the various systems and methods disclosed herein may operate. In embodiments, a client device, such as client device 602, may communicate with one or more servers, such as servers 604 and 606, via a network 608. In embodiments, a client device may be a laptop, a personal computer, a smart phone, a PDA, a netbook, a netbook, a tablet, a phablet, a convertible laptop, a television, or any other type of computing device, such as the computing device in FIG. 6. In embodiments, servers 604 and 606 may be any type of computing device, such as the computing device illustrated in FIG. 6. Network 608 may be any type of network capable of facilitating communications between the client device and one or more servers 604 and 606. Examples of such networks include, but are not limited to, LANs, WANs, cellular networks, a WiFi network, and/or the Internet.

In embodiments, the various systems and methods disclosed herein may be performed by one or more server devices. For example, in one embodiment, a single server, such as server 604 may be employed to perform the systems and methods disclosed herein. Client device 602 may interact with server 604 via network 608 in order to access data or information such as, for example, a video data for self-similarity upsampling. In further embodiments, the client device 606 may also perform functionality disclosed herein.

In alternate embodiments, the methods and systems disclosed herein may be performed using a distributed computing network, or a cloud network. In such embodiments, the methods and systems disclosed herein may be performed by two or more servers, such as servers 804 and 806. In such embodiments, the two or more servers may each perform one or more of the operations described herein. Although a particular network configuration is disclosed herein, one of skill in the art will appreciate that the systems and methods disclosed herein may be performed using other types of networks and/or network configurations.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

We claim:

1. A method of performing upsampling, the method comprising:
receiving an input image;
generating an initial upsampled image using the input image;
generating a low-passed image using the input image; and
performing self-similarity upsampling using the upsampled image and the low-passed image.
